(19) United States
(12) Patent Application Publication
(10) Pub. No.: US 2020/0280039 A1
(43) Pub. Date: Sep. 3, 2020

(54) Separators Including Thermally Activated Ionic-Flow-Control Layers, and Electrochemical Devices Incorporating Same

(71) Applicant: SES Holdings Pte, Ltd., Singapore (SG)

(72) Inventors: Shubha Nageswaran, Billerica, MA (US); Mackenzie King, Essex, MA (US); Robert Graves, Methuen, MA (US); Qichao Hu, Arlington, MA (US)

(21) Appl. No.: 16/804,136

(22) Filed: Feb. 28, 2020

Related U.S. Application Data
(60) Provisional application No. 62/812,347, filed on Mar. 1, 2019.
(60) Provisional application No. 62/830,608, filed on Apr. 8, 2019.
(60) Provisional application No. 62/832,656, filed on Apr. 11, 2019.

(51) Int. Cl. H01M 2/16; H01M 10/0525

(52) U.S. Cl. CPC H01M 2/1686; H01M 10/0525; H01M 2/1653; H01M 2/1646

(57) ABSTRACT

Separators, for use in electrochemical devices, that each include a porous body and at least one ionic-flow-control layer that includes at least one copolymer blend tuned to melt at a design temperature so that, when melted, the copolymer blend block the flow of ions of an electrolyte through the porous separator. In some embodiments, each copolymer blend is applied to the porous body in particulate form. In some embodiments, two or more copolymer blends of differing design melting temperatures are provided to the ionic-flow-control layer. In embodiments having multiple differing copolymer blends of differing melting temperatures, the copolymer blends may be provided in the ionic-flow-control layer in discrete regions or as a mixture of un-melted particles. An ionic-flow-control layer may be provided separately from or integrally with a porous separator body. Electrochemical devices including ionic-flow-control layers are also disclosed.

### RELATED APPLICATION DATA

This application claims the benefit of priority of U.S. Provisional Patent Application Ser. No. 62/812,347, filed Mar. 1, 2019, and titled “THERMALLY ACTIVATED SHUTDOWN SEPARATOR FOR LI METAL BATTERY”, and of U.S. Provisional Patent Application Ser. No. 62/830,608, filed Apr. 8, 2019, and titled “THERMALLY ACTIVATED SHUTDOWN SEPARATOR FOR LI METAL BATTERY”, and of U.S. Provisional Patent Application Ser. No. 62/832,656, filed Apr. 11, 2019, and titled “THERMALLY ACTIVATED SHUTDOWN SEPARATOR FOR LI METAL BATTERY”, each of which is incorporated by reference herein in its entirety.

### FIELD OF THE INVENTION

The present invention generally relates to the field of electrochemical devices. In particular, the present invention is directed to separators including thermally activated ionic-flow-control layers and electrochemical devices incorporating same.

### BACKGROUND

Under various and usually unavoidable circumstances, such as internal shorting, puncturing, or overcharging, various types of electrochemical devices, such as lithium-ion and lithium-metal batteries, can experience thermal runaway that can cause them to catch fire and/or explode if allowed to overheat. Lithium-based batteries are pervasive in society, with them being used in mobile computing devices from smartwatches, to cell phones, to tablet and laptop computers, to tools, such as cordless hand-tools to lawn mowers, and to an ever-growing list of vehicles, including cars, trucks, and aerial drones, among many others. Consequently, operating safety of lithium-based batteries is of critical importance.

Thermal runaway is a well-known safety issue with lithium-based batteries. Due to the relatively low temperatures and exothermic nature of thermal runaway, thermal runaway needs to be shut down to prevent it from continuing and especially from reaching the melting point of lithium (179° C.) and/or causing the rapid vaporization of electrolyte solvents at which point a resulting fire and/or explosion that the thermal runaway causes could be catastrophic. This concern is becoming increasingly heightened as lithium-based batteries are being deployed more and more for high power applications and as electrical storage capacities are getting larger.

### SUMMARY OF THE DISCLOSURE

In an implementation, the present disclosure is directed to a separator for an electrolytic device that utilizes an electrolyte containing ions. The separator includes a porous body having a first side and a second side spaced from the first side, the porous body configured to allow movement of the ions through the porous body when the separator is immersed in the electrolyte in the electrolytic device; and an ionic-flow-control layer functionally located relative to the porous body, wherein the ionic-flow-control layer comprises a first plurality of particles each comprising a first copolymer blend compositionally tuned to melt at a first design melting temperature, wherein when the ionic-flow-control layer has not been subjected to the first design melting temperature and the separator is immersed in the electrolyte, the ionic-flow-control layer has a porosity that allows movement of the ions through the ionic-flow-control layer and permit the ions to flow through the separator; and when the ionic-flow-control layer has been subjected to the first design melting temperature or greater and the separator is immersed in the electrolyte, the first plurality of particles melt so as to reduce the porosity of the ionic-flow-control layer and thereby inhibit flow of the ions through the separator.

In one or more embodiments of the separator, the porous body comprises a porous polymer having a melting temperature greater than the first design melting temperature.

In one or more embodiments of the separator, the porous body comprises a porous polymer and a ceramic material coated onto the polymer.

In one or more embodiments of the separator, the porous polymer consists essentially of polypropylene.

In one or more embodiments of the separator, the porous polymer consists essentially of polyethylene.

In one or more embodiments of the separator, the porous body comprises a ceramic material.

In one or more embodiments of the separator, the ionic-flow-control layer is a coating applied to the porous body.

In one or more embodiments of the separator, the first copolymer blend comprises a longer-chain polymer and a shorter-chain polymer.

In one or more embodiments of the separator, the long chain polymer comprises polyethylene and the softer polymer comprises vinyl acetate.

In one or more embodiments of the separator, the first copolymer blend comprises a blend of at least three copolymers.

In one or more embodiments of the separator, the mean size of the first plurality of particles is in a range of about 1 microns to about 10 microns.

In one or more embodiments of the separator, the average spacing between adjacent particles in the first plurality of particles is in a range of about 2 microns to about 5 microns.

In one or more embodiments of the separator, the average spacing between adjacent particles in the first plurality of particles is in a range of about 4 microns to about 8 microns.

In one or more embodiments of the separator, each of the first plurality of particles is substantially spherical in shape.

In one or more embodiments of the separator, each of the first plurality of particles is substantially cubical in shape.

In one or more embodiments of the separator, the particular layer comprises a binder.

In one or more embodiments of the separator, the porous separator has a functional area, and at least 80% of the functional area is covered by the particular layer.

In one or more embodiments of the separator, the ionic-flow-control layer is composed of a single layer of the first plurality of particles.

In one or more embodiments of the separator, the first design melting temperature is in a range of about 60° C. to about 100° C.

In one or more embodiments of the separator, the first design melting temperature is in a range of about 90° C. to about 120° C.

In one or more embodiments of the separator, the ionic-flow-control layer is configured to further reduce flow of the ions through the separator when the temperature of the ionic-flow-control layer reaches a second design melting temperature higher than the first design melting temperature, the ionic-flow-control layer comprises a second plurality of particles each comprising a second copolymer blend compositionally tuned to melt substantially at the second design melting temperature so as to further reduce the porosity of the ionic-flow-control layer and thereby further inhibit flow of the ions through the separator.

In one or more embodiments of the separator, the second plurality of particles are distributed throughout the first plurality of particles within the ionic-flow-control layer.

In one or more embodiments of the separator, the ionic-flow-control layer has first and second regions that are distinct from one another, and the first plurality of particles are clustered with one another in the first region and the second plurality of particles are clustered with one another in the second region.

In one or more embodiments of the separator, the first and second regions are located adjacent to one another so as to define a boundary, and the first plurality of particles have an abrupt transition to the second plurality of particles at the boundary.

In one or more embodiments of the separator, the first and second regions are located adjacent to one another so as to define a boundary, and the first plurality of particles have a graded transition to the second plurality to the second plurality of particles at the boundary.

In one or more embodiments of the separator, the first and second regions are both located on the first side of the porous body.

In one or more embodiments of the separator, the first region is on the first side of the porous body and the second region is on the second side of the porous body.

In one or more embodiments of the separator, the first design melting temperature is in a range of about 65° C. to about 100° C. and the second design melting temperature is in a range of about 90° C. to about 120° C.

In one or more embodiments of the separator, the ionic-flow-control layer is located on only the first side of the porous body.

In one or more embodiments of the separator, the ionic-flow-control layer is located on each of the first and second sides of the porous body.

In some aspects, the present disclosure is directed to an energy storage device, comprising an anode; a cathode; an electrolyte in ionic communication with the anode and cathode; and an ionic-flow-control (IFC) structure for reducing flow of ions in the electrolyte between the anode and cathode when a temperature of the separator reaches a first design melting temperature, the separator including: a porous body having a first side, a second side spaced from the first side, and pores provided for allowing movement of the ions through the porous body; and a particulate layer functionally located relative to the porous body, wherein the particulate layer comprises a first plurality of particles each composed at least partially of a first copolymer blend tuned to melt substantially at the first design melting temperature, wherein when the first plurality of particles melt at substantially the first design melting temperature to form a first melt, the first melt blocks the ionic flow through a first portion of the pores.

In one or more embodiments of the energy storage device, the first copolymer blend comprises a long-chain polymer and a softer polymer.

In one or more embodiments of the energy storage device, the long chain polymer comprises polyethylene and the softer polymer comprises vinyl acetate.

In one or more embodiments of the energy storage device, the first copolymer blend comprises a blend of at least three copolymers.

In one or more embodiments of the energy storage device, the mean size of the first plurality of particles is in a range of about 1 microns to about 10 microns.

In one or more embodiments of the energy storage device, the average spacing between adjacent particles in the first plurality of particles is in a range of about 2 microns to about 5 microns.

In one or more embodiments of the energy storage device, the average spacing between adjacent particles in the first plurality of particles is in a range of about 4 microns to about 8 microns.

In one or more embodiments of the energy storage device, each of the first plurality of particles is substantially spherical in shape.

In one or more embodiments of the energy storage device, each of the first plurality of particles is substantially cubical in shape.

In one or more embodiments of the energy storage device, the particular layer comprises a binder.

In one or more embodiments of the energy storage device, the porous separator has a functional area, and at least 80% of the functional area is covered by the particular layer.

In one or more embodiments of the energy storage device, the particulate layer is composed of a single layer of the first plurality of particles.

In one or more embodiments of the energy storage device, the first design melting temperature is in a range of about 60° C. to about 100° C.

In one or more embodiments of the energy storage device, the first design melting temperature is in a range of about 90° C. to about 120° C.

In one or more embodiments of the energy storage device, the separator is for further reducing flow of the ions when the temperature of the separator reaches a second design melting temperature higher than the first design melting temperature, and the particulate layer comprises a second plurality of particles each composed at least partially of a second copolymer blend tuned to melt substantially at the second design melting temperature, wherein when the second plurality of particles melt at substantially the second design melting temperature to form a second melt, the second melt blocks the ionic flow through a second portion the pores different from the first portion of the pores.

In one or more embodiments of the energy storage device, the porous body has first and second regions that are distinct from one another, and the first plurality of particles are located exclusively in the first region and the second plurality of particles are located exclusively in the second region.

In one or more embodiments of the energy storage device, the first and second regions are on the first side of the porous body.

In one or more embodiments of the energy storage device, the first region is on the first side of the porous body and the second region is on the second side of the porous body.

In one or more embodiments of the energy storage device, the first design melting temperature is in a range of about 60° C. to about 100° C. and the second design melting temperature is in a range of about 90° C. to about 120° C.

In one or more embodiments of the energy storage device, the particulate layer is located on only the first side of the porous body.

In one or more embodiments of the energy storage device, the particulate layer is located on each of the first and second sides of the porous body.

In one or more embodiments of the energy storage device, the porous body comprises an electrical separator.

In one or more embodiments of the energy storage device, the porous body comprises a porous polymer having a melting temperature greater than the first design melting temperature.

In one or more embodiments of the energy storage device, the porous polymer is coated with a ceramic material, and the particulate layer is applied to the ceramic material.

In one or more embodiments of the energy storage device, the porous polymer consists essentially of polypropylene.

In one or more embodiments of the energy storage device, the porous polymer consists essentially of polyethylene.

In one or more embodiments of the energy storage device, the first design melting temperature is selected to inhibit thermal runaway.

In one or more embodiments of the energy storage device, the electrolyte comprises an alkali-metal bis(fluorosulfonyl)imide (FSI) salt, and the first design melting temperature is in a range of about 65° C. to about 100° C.

In one or more embodiments of the energy storage device, the copolymer blend comprises a blend of polyethylene and vinyl acetate.

In one or more embodiments of the energy storage device, the electrolyte comprises a lithium FSI salt.

In one or more embodiments of the energy storage device, the particulate layer comprises two or more pluralities of particles, and the particles in each of the pluralities of particles are tuned to have a design melting temperature that is different from the design melting temperature of each other of the pluralities of particles.

In one or more embodiments of the energy storage device, the particles in a first of the pluralities of particles have a first design melting temperature and the particles in a second of the pluralities of particles have a second design melting temperature different from the first design melting temperature.

In one or more embodiments of the energy storage device, each of the first and second design melting temperatures is selected to inhibit thermal runaway within the energy storage device.

In some aspects, the present disclosure is directed to a method of making an ionic-flow-control (IFC) structure for reducing flow of ions of an electrolyte through the separator as a function of a first design melting temperature at which it is desired the separator activate to begin reducing the flow of ions, the method comprising: providing a porous body having a first side, a second side spaced from the first side, and pores provided for allowing movement of the ions through the porous body; providing first particles of a first copolymer blend having a first melting temperature substantially equal to the first design melting temperature; and depositing the first particles onto the porous body so that, when the first particles melt to form a first melt, the first melt blocks at least a first portion of the pores so as to prevent the flow of ions therethrough.

In one or more embodiments of the method, the separator is for an energy storage device, and the first design melting temperature is selected to inhibit thermal runaway of the energy storage device.

In one or more embodiments of the method, providing first particles of a first copolymer blend includes providing first particles having a diameter from about 1 micron to about 10 microns in diameter.

In one or more embodiments of the method, providing first particles of a first copolymer blend includes selecting a longer-chain polymer and a softer polymer and adjusting a ratio between the longer-chain polymer and the softer polymer so that the first copolymer blend melts substantially at the first design melting temperature.

In one or more embodiments of the method, providing first particles of a first copolymer blend includes providing a first copolymer blend comprising polyethylene and vinyl acetate.

In one or more embodiments of the method, mixing the first particles with a binder to form a mixture prior to depositing the first particles onto the porous body, wherein depositing the first particles onto the substrate includes depositing the mixture onto the porous body.

In one or more embodiments of the method, depositing the first particles onto the porous body includes depositing the first particle on only one of the first and second sides of the porous body.

In one or more embodiments of the method, depositing the first particles onto the porous body includes depositing the first particle on each of the first and second sides of the porous body.

In one or more embodiments of the method, the separator has a second design melting temperature different from the first design melting temperature, and the method further comprises providing second particles of a second copolymer blend having a second melting temperature substantially equal to the second design melting temperature; and depositing the first particles onto the porous body so that, when the second particles melt to form a second melt, the second melt blocks at least a second portion of the pores different from the first portion of the pores so as prevent the flow of ions therethrough.

In one or more embodiments of the method, depositing the first particles onto the porous body includes depositing the first particles in a first region, the method further including depositing the second particles in a second region distinct from the first region.

In one or more embodiments of the method, the first and second regions are on only one of the first and second sides of the porous body.

In one or more embodiments of the method, the first and second regions are differing ones of the first and second sides of the porous body.

In one or more embodiments of the method, the first design melting temperature is in a range of about 60° C. to about 100° C. and the second design melting temperature is in a range of about 90° C. to about 120° C.

In one or more embodiments of the method, the first copolymer blend and the second copolymer blend are composed of the same constituent materials but in different ratios relative to one another.

In one or more embodiments of the method, the constituent materials include polyethylene and vinyl acetate.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a diagrammatic cross-sectional view of an electrochemical device that includes at least one ionic-flow-control (IFC) layer of the present disclosure;

FIG. 1B is an enlarged partial view of the separator and two IFC layers each comprising particles composed on one or more polymer blends;

FIG. 1C is the enlarged partial view of FIG. 1B after the first of the two IFC layers has melted;

FIG. 1D is the enlarged partial view of FIGS. 1B and 1C after the second of the two IFC layers has melted;

FIG. 2A is a plan view of an example IFC structure illustrating an example arrangement of IFC regions of differing design melting temperatures;

FIG. 2B is a plan view of another example IFC structure illustrating another example arrangement of IFC regions of differing design melting temperatures;

FIG. 2C is a plan view of another example IFC structure illustrating an IFC layer having a gradation of design melting temperatures;

FIG. 3A is a plan view of an example IFC layer having a striped arrangement of regions of differing polymer blends having differing design melting temperatures; and

FIG. 3B is a plan view of another example IFC layer having a mixture of particles of differing polymer blends having differing design melting temperatures.

### DETAILED DESCRIPTION

In some aspects, the present disclosure is directed to ionic-flow-control (IFC) structures and IFC layers for use in electrochemical devices, such as batteries, capacitors, and supercapacitors, in which it is desirable to control flow of ions of the electrolytes within the electrochemical devices as a function of temperature. Examples of electrochemical devices that can benefit from IFC technology of the present disclosure include, but are not limited to, lithium-based batteries, such as lithium-ion batteries and lithium-metal batteries, among others. As described in the Background section above, the phenomenon of thermal runaway in lithium-based batteries is well known. A number of technologies are known for shutting down the flow of ions within lithium-based batteries. One of these technologies uses a separator that includes a polyethylene layer that melts at a design temperature to form a melt that blocks the flow of ions in the electrolyte through the separator.

The present inventors have recognized that while the use of polyethylene—or even another commercial off-the-shelf type polymer—is beneficial, the melting points of these materials are not always ideal for a particular application. Consequently, in some embodiments an IFC layer of the present disclosure comprises one or more polymer blends, each of which comprises a copolymer blend of two or more polymers, wherein the polymers and their relative amounts in the polymer blend are selected so that the polymer blend melts at, or nearly at, a specific design temperature that is tuned to the particular application at issue. For the sake of the present disclosure and the appended claims, the term “melts at”, or the like, when used in conjunction with a “design melting temperature”, “design temperature”, “temperature”, or the like, shall in some embodiments mean within +/−10° C. of the relevant temperature value, in some embodiments mean within +/−8° C. of the relevant temperature value, in some embodiments mean within +/−5° C. of the relevant temperature value, and in some embodiments mean within +/−2° C. of the relevant temperature value. Prior to melting at the design melting temperature, and IFC layer of the present disclosure, or a corresponding region thereof, contains passageways, such as inter-particle spaces, openings, and/or pores, that permits the flow of ions of an electrolyte through the IFC layer. Example IFC layers are described below.

As mentioned above, one or more IFC layers can be incorporated into any of a variety of electrochemical devices to control ionic flow within the electrolyte of the corresponding electrochemical device. For example, one or more IFC layers can be integrated with a separator located between the cathode and anode of the electrochemical device. As those skilled in the art understand, a separator is a dielectric structure that, during normal operation, physically separates the anode and cathode of an electrochemical device while allowing ions of a suitable electrolyte to move through the separator between the anode and cathode during discharging and charging cycles. Typically, the electrolyte at issue is a liquid or gel-type electrolyte, though one or more IFC layers can be used with solid electrolytes as well. For the sake of convenience, any structure (e.g., separator, support structure, IFC layer, etc.) described herein as allowing ions within a liquid electrolyte or gel electrolyte to pass through that structure is denoted as a “porous” structure. It is to be understood, however, that the porosity of the structure need not be provided by pores. Rather, the porosity may be provided by other ionic flow passageways, such as apertures, channels, interparticle spaces, and/or openings, among others.

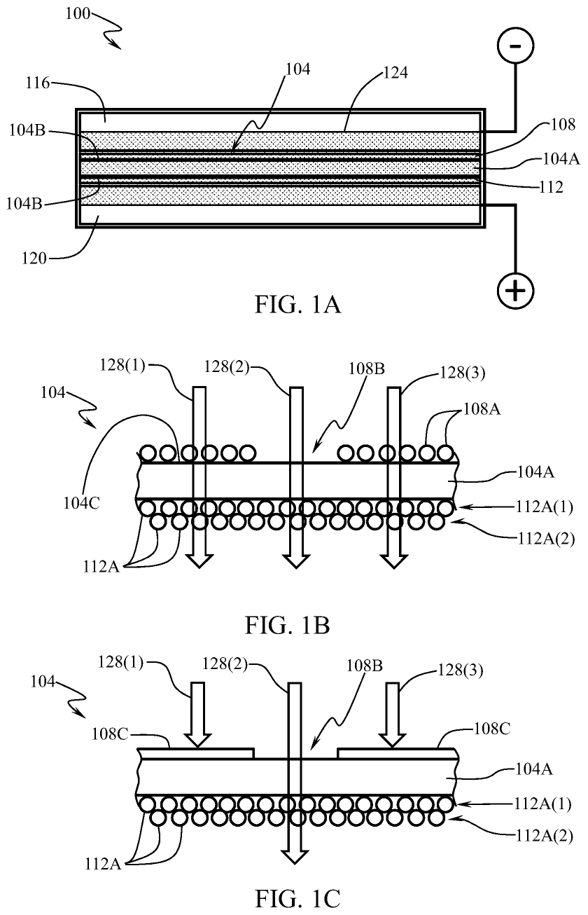

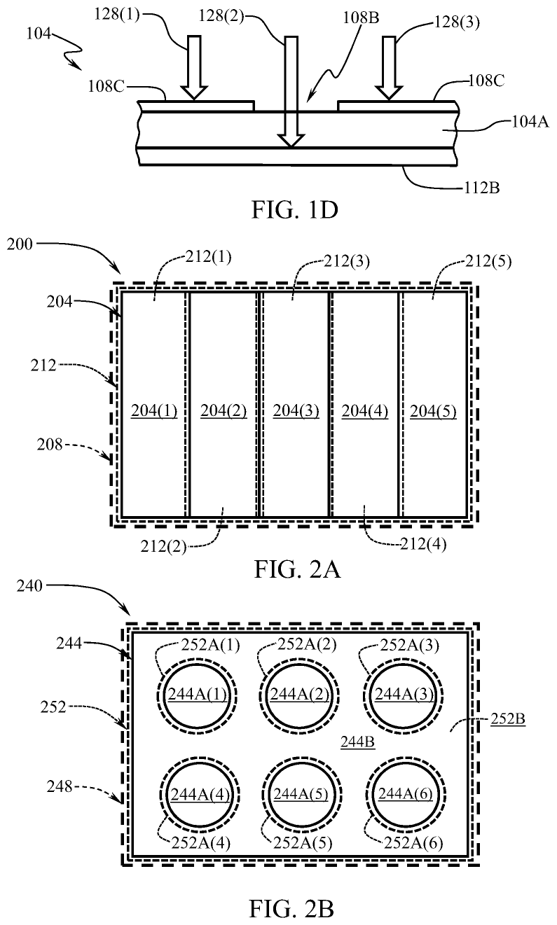

For the sake of illustration, FIG. 1A shows an example electrochemical device 100 comprising a separator 104 that includes a porous body 104A and at least one IFC layer, here, a first IFC layer 108 located on one side of the porous body and an optional second IFC layer 112 located on the opposite side of the porous body. In this example, each of the first and second IFC layers 108 and 112 has a corresponding minimum design melting temperature TMmin108 and TMmin112, respectively, which is the lowest temperature at which the corresponding IFC layer is designed to melt, and a corresponding maximum design melting temperature TMmax108 and TMmax112, respectively, which is the highest temperature at which the corresponding IFC layer is designed to melt. As discussed below, an IFC layer made in accordance with the present disclosure, such as the first and second IFC layers 108 and 112, may have more than one design melting temperature, hence the use of minimum and maximum design melting temperatures. The entirety of either or both of the first and second IFC layers 108 and 112 is designed to melt at only one temperature, TMmin=TMmax, and the design melting temperature may be expressed simply as TM, for example, here TM108 and TM112 for, respectively, the first and second IFC layers 108 and 112.

In this example, the porous body 104A and the first and second IFC layers 108 and 112 are located between an anode 116 and a cathode 120 of the electrochemical device 100, and are immersed in an electrolyte 124 within the electrochemical device. In some embodiments, the electrolyte 124 may be a liquid electrolyte or a gel electrolyte, or a combination thereof. As is well known in the art and therefore needless to say, the electrolyte may include any one or more types of salts, any one or more types of solvents, and any one or more types of additives and may further include one or more other components, such as at least one polymer in the case of a gel electrolyte. Fundamentally, there is no limitation on the composition of the electrolyte 124; it need only provide working ions (not shown) that flow between the anode 116 and the cathode 120. It is noted that the electrolyte 124 is shown in FIG. 1A as extending into both the anode 116 and cathode 120. This is to express the fact that in some embodiments of the electrochemical device, one, the other, or both of the anode 116 and cathode 120 may be porous.

Each of the anode 116 and cathode 120 may be made of any suitable material(s), with the selection of the material(s) for each being based on the type of the electrochemical device 100. For example, if the anode 116 is a lithium-ion type anode, then it may be made of one or more materials designed to intercalate lithium ions in the electrolyte 124, as can be the cathode 120. As another example, if the anode 116 is a lithium-metal type anode, then it may be made of one or more materials designed to be plated upon by lithium ions in the electrolyte 124, and the cathode 120 may be made of any one or more suitable materials, such as one or more materials designed for intercalating the lithium ions in the electrolyte. It is noted that lithium chemistry is only one example of a chemistry suitable for electrochemical device l and that other chemistries, such as sodium chemistry, magnesium chemistry, and aluminum chemistry, among others, can benefit from the IFC-layer technology disclosed herein. The particular chemistry at issue for any given type of the electrochemical device 100 is pertinent to the present disclosure to the extent that the chemistry is such that temperature excursions are possible and that it is desirable or necessary to control such an excursion and the underlying chemical process(es) causing the excursion. Those skilled in the art will readily appreciate when and how to implement the IFC-layer technology disclosed herein depending upon the chemistry selected. It is noted that FIG. 1A illustrates only a single layer for each of the anode 116, cathode 120, and separator 104. This is done merely for simplicity. Those skilled in the art will readily appreciate that an actual instantiation of the electrochemical device 100 would more typically include either a stack or a coil of such layers.

In some embodiments, the porous body 104A may be made of any one or more suitable materials such that the porous body does not melt or otherwise lose stability at the maximum design melting temperature of both of the first and second IFC layers 108 and 112. In these embodiments, this allows the porous body 104A to provide support for one or both of the first and second IFC layers 108 and 112 prior to and/or after melting. In some embodiments, the porous body 104A provides support for one or both of the first and second IFC layers 108 and 112 by virtue of the first and second IFC layer(s) being applied or otherwise secured to the separator during fabrication, i.e., prior to experiencing melting. As with each of the first and second IFC layers 108 and 112 prior to melting, the porous body 104A is configured with passageways that permit ions (not shown) from the electrolyte 124 to move through the porous body from one side of the separator to the other between the anode 116 and the cathode 120. In one example, the separator 104 is made of one or more polymers, such as polypropylene, polyethylene, or poly(vinylidene fluoride), among others, or any combination thereof In one example, the porous body 104A includes one or more coatings, such as a ceramic coating 104B, a polymeric coating, and/or a composite coating, among others, to provide any desired effect(s), such as improving wetting and inhibiting shrinkage. Other separator constructions are possible. Those skilled in the art understand the generalities of separator design and construction and, so, can design and construct a porous body suitable for use with one or more IFC layers of the present disclosure.

Each of the first and second IFC layers 108 and 112 may take any of a variety of forms. For example and as mentioned above, prior to melting, each of the first and second IFC layers 108 and 112 includes passageways that allow ions of the electrolyte 124 to flow through the IFC layer (i.e., is “porous” as defined above), and these passageways can be provided by, for example, inter-particle spaces when the IFC layer comprises particles of the one or more polymer blends used to make the IFC layer, pores within an otherwise solid layer of the one or more polymer blends, and apertures formed in an otherwise solid layer of the one or more polymer blends, and any combination thereof.

When one or the other or both of the first and second IFC layers 108 and 112 comprise particles 108A, 112A (FIG. 1B, only a few labeled for convenience), the particles may be applied to the porous body 104A in any suitable manner. In one example, a binder (not shown), such as polyvinylidene fluoride (PVDF), styrene butadiene (SBR), or poly acrylonitrile (PAN), among others, is used to secure the particles 108A, 112A to the porous body 104A. If each of the first and second IFC layer 108, 112 is provided as a porous (e.g., apertured or pored) film, it may be attached to the porous body in a suitable manner, such as using an adhesive (not shown). In some embodiments, each or both of the first and second IFC layers 108 and 112 may not be attached to the porous body 104A. In such embodiments, the first and second IFC layer(s) 108, 112 may be held in place by compressive forces present when the IFC layer(s) 108, 112 is/are located in situ within the assembled electrochemical device 100.

Referring to FIG. 1B, in the example illustrated, the first IFC layer 108 is a monolayer of particles 108A, and the particles are substantially spherical in shape and are generally uniform in size relative to one another, such that even when the particles are packed tightly in the monolayer, they form the spaces that permit ions from the electrolyte 124 to flow through the IFC layer. It is noted that the particles 108A need not be spherical and need not be uniform in size. Generally, any shape can be used as long as sufficient interparticle space is provided for the ionic flow. Similarly, the size of the particles 108A need not be uniform, as long as they provide the necessary/desired ionic flow through the IFC layer 108 prior to any melting.

In some embodiments, all of the particles 108A may comprise the same polymer blend such that the entire IFC layer 108 has a uniform design melting temperature. In some embodiments, differing ones of the particles 108A may be composed of two or more differing polymer blends so as to have differing design melting temperatures. Providing one or more IFC layers or partial layers (i.e., a layer that does not cover the entire flow area of the separator or other support structure), such as the first and second IFC layers 108 and 112, can be beneficial for any one or more of a variety of reasons. For example, in the case of thermal runaway, the thermal runaway can be controlled while still allowing the electrochemical device 100 (FIG. 1A) to function, albeit at a reduced capacity. This can be extremely important in certain applications of the electrochemical device 100 (FIG. 1A), such as when the electrochemical device is providing power to a manned aerial vehicle or emergency radio transmitter where a complete loss of power would be life-threatening.

In one example of the first IFC layer 108 having two or more design melting temperatures, the ones of the particles 108A having one design melting temperature may be grouped exclusively with one another so as to form differing regions across the surface 104C of the porous body 104A so that the differing regions have uniformly differing design melting temperatures. As another example, when the particles 108A are composed of particles that differ in design melting temperature, the particles can be combined in a graded manner according to their design melting temperature so as to provide the first IFC layer 108 with multiple design melting temperatures that gradually change from one region of the IFC layer to another. Example configurations for IFC layers having a single design melting temperature and multiple design melting temperatures are described below in connection with FIGS. 2A to 2C.

The example of FIG. 1B shows the second IFC layer 112 as having its particles 112A provided in a manner other than a monolayer, here, in two layers 112A(1) and 112A(2). It is noted that while two layers 112A(1) and 112A(2) are shown, more layers can be provided to suit a particular design. In addition, depending on the sizes of the particles 112A, the particles may not be organized in discrete layers. Regardless of the structure of a non-monolayer assembly of particles 112A, general principles described above relative to IFC layer 108 concerning the areal arrangement of regions of differing design melting temperatures and graduated design melting temperatures may be applied to IFC layer 112.

In the example specifically illustrated in FIG. 1B, all of the particles 108A of the first IFC layer 108 may be made of the same polymer blend so that the entire first IFC layer has a single design melting temperature TMlow, and the first IFC layer is shown as having an opening 108B where no particles 108A exist. Continuing with this example, all of the particles 112A of the second IFC layer 112 may be made of the same polymer blend so that the entire second IFC layer has a single design melting temperature TMhigh that is higher than TMlow of the first IFC layer 108. When the temperature of the separator 104 is lower than TMlow, ionic flow can occur across the entirety of the IFC structure, as indicated by flow arrows 128(1) to 128(3). At this point, the electrochemical device can operate at full capability.

When the temperature of the separator 104 meets or exceeds TMlow of the first IFC layer 108 but remains lower than TMhigh of the second IFC layer 112, the first IFC layer melts as illustrated in FIG. 1C, with the melted particles 108A (FIG. 1B) forming a first barrier layer 108C (FIG. 1C) that blocks ionic flow in the corresponding regions as illustrated by the flow arrows 128(1) and 128(3) terminating at the first barrier layer. However, the opening 108B remains, allowing ionic flow to continue at that region of the first IFC layer 108 as illustrated by flow arrow 128(2) still passing through the separator 104. This reduced ionic flow allows the electrochemical device 100 to continue operating, though at a reduced capability. If the temperature of the separator 104 increases to or exceeds TMhigh of the second IFC layer 112, the particles 112A in the second IFC layer melt to form a corresponding second barrier layer 112B (FIG. 1D). At this point, the portion of the ionic flow that was still occurring after the first IFC layer 108 melted (see, flow arrow 128(2)) is now blocked by the second barrier layer 112B so as to stop all ionic flow through the separator 104, effectively shutting down the operation of the electrochemical device.

FIG. 2A illustrates an example IFC structure 200 that includes a first IFC layer 204 composed of five regions 204(1) through 204(5), here appearing in a striped arrangement. The number of regions can be greater or fewer in other embodiments. In addition, the shapes of the regions may be different in different embodiments, and the arrangement may be different. Regarding the latter and in the context of the striped regions 204(1) to 204(5) illustrated, the direction of striping may be oriented differently from the origination shown, such as perpendicular to the arrangement shown or diagonally relative to the rectangular shape of the IFC structure shown. Depending on the ionic-flow control requirements/desires of a particular design, the differing regions 204(1) to 204(5) may be provided with differing design melting temperatures, for example, using any of the IFC-layer techniques described above and exemplified below that utilize polymer blends tuned to differing design melting temperatures. The following Table I illustrates nine different configurations of the first IFC layer 204, two configurations for a single design melting temperature (TM) (configurations 1A and 1B), two configurations for two design melting temperatures (configurations 2A and 2B), and five configurations for three design melting temperatures (configurations 3A through 3E). It is noted that these example configurations are not exhaustive but illustrative.

TABLE I

| | Single TM Conf. | | 2 TM Config. | | 3 TM Configuration | | | | |
|---|---|---|---|---|---|---|---|---|---|
| Region | 1A | 1B | 2A | 2B | 3A | 3B | 3C | 3D | 3E |
| 204(1) | S | N | L | H | L | H | L | H | M |
| 204(2) | N | S | H | L | M | M | H | L | H |
| 204(3) | S | N | L | H | H | L | M | M | L |
| 204(4) | N | S | H | L | M | M | H | L | H |
| 204(5) | S | N | L | H | L | H | L | H | M |

Legend:
S = single design temperature polymer blend
N = no polymer blend (no flow blocking)
L = low design temperature polymer blend
M = medium design temperature polymer blend
H = high design temperature polymer blend
Note:
the “low”, “medium”, and “high” designations are relative to one another

As can be seen generally in the Table I, above, for the single design melting temperature configurations 1A and 1B of the first IFC layer 204, the first IFC layer has blocking capabilities only in certain ones of regions 204(1) to 204(5) upon melting of the polymer blend S. This leaves others of the regions 204(1) to 204(5) open to ionic flow after melting. Consequently, the corresponding electrochemical device (not shown, but may be similar to electrochemical device 100 of FIG. 1A) can continue to operate after the polymer blend S has melted, albeit at a reduced output. In some embodiments, it can be desirable to limit the amount of the ionic flow area (in a direction normal to the first IFC layer 204) that remains open after melting to no more than about 80% of the original ionic flow area prior to melting of the polymer blend S.

With continuing reference to the Table I above, for the two design melting temperature configurations 2A and 2B of the first IFC layer 204 of FIG. 2A, the low design melting temperature polymer blend L is tuned to melt at a lower temperature than the high design melting temperature poly blend H. During an excursion, when the temperature of the first IFC layer 204 reaches the design melting temperature of polymer blend L, the polymer blend L melts, and the electrochemical device (not shown, but may be similar to electrochemical device 100 of FIG. 1A) can continue to operate at a reduced ionic flow due to the blockage of the ionic flow in the ones of the regions 204(1) to 204(5) in which the polymer L has melted. This reduced-flow operation can continue as long as the temperature of the first IFC layer 204 remains below the melting temperature of the high design melting temperature polymer blend H. In the two configurations 2A and 2B illustrated, once the temperature of the first IFC layer 204 reaches or exceeds the melting temperature of the polymer blend H, the polymer blend H in the corresponding ones of the regions 204(1) to 204(5) melts so as to block the flow of ions (not shown) through those regions. At this point, since both of the low and high design melting temperature polymer blends L and H, respectively, have melted and since the regions 204(1) to 204(5) cover the entire original flow area of the first IFC layer 204, the flow of ions through the first IFC layer is completely stopped. It is noted that while not shown, if some non-zero amount of ionic flow through the first IFC layer 204 is desired after the higher design melting temperature of polymer blend H has been reached, one or more of the regions 204(1) to 204(5) may not be provided with any polymer blend, thereby leaving such region(s) open for ionic flow.

The Table I, above, illustrates five example design melting temperature configurations 3A to 3E of the first IFC layer 204 of FIG. 2A when three differing polymer blends L, M, and H are used and the polymer blends have three differing design melting temperatures. The functioning of each of these configurations 3A to 3E is generally similar to the configurations 2A and 2B in that it provides a progressive blocking of ionic flow with increasing temperature. However, with the inclusion of the polymer blend M having a design melting temperature between the design melting temperatures of the polymer blends L and H, the change in the ionic flow blocking ability of the first IFC layer 204 is more gradual than when only two polymer blends L and H are used. It is noted that while not shown, if some non-zero amount of ionic flow through the first IFC layer 204 is desired after the highest design melting temperature of polymer blend H has been reached, one or more of the regions 204(1) to 204(5) may not be provided with any polymer blend, thereby leaving such region(s) open for ionic flow.

The IFC structure 200 of FIG. 2A may optionally include a support structure 208 for supporting the first IFC layer 204. The support structure 208 is sufficiently porous or otherwise open to the flow of ions of an electrolyte (not shown) from one side of the IFC structure 200 to the other, here, either into or out of the page relative to FIG. 2A. The support structure 208 is also robust enough to withstand at least the highest design melting temperature at which the first IFC layer 204 is designed to operate without losing its ability to support the first IFC layer 204. The support structure 208, when provided, is typically a separator that provides electrical separation between an anode and a cathode of an electrochemical device, for example, as discussed above relative to FIGS. 1A and 1B. Those skilled in the art will understand how to construct or provide a suitable porous support structure 208.

The IFC structure 200 of FIG. 2A may optionally include a second IFC layer 212, such as on the side of the support structure 208 opposite the side that the first IFC layer 204 is on. If present, the second IFC layer 212 may be configured, in terms of number, location, and size of the regions, in the same manner as the first IFC layer 204. In the example shown, in this case the second IFC layer 212 would have five regions 212(1) to 212(5) that match the regions 204(1) to 204(5) of the first IFC layer 204 but be located on the opposite side of the support structure 208. In embodiments in which the regions 212(1) to 212(5) of the second IFC layer 212 match the regions 204(1) to 204(5) of the first IFC layer 204, the individual regions may have the same or differing polymer blend, or none, as the corresponding individual regions 204(1) to 204(5) on the opposite side of the support structure 208. In some embodiments, the second IFC layer 212 may be configured differently from the configuration of the first IFC layer 204. For example, the entirety of the second IFC layer 212 may be composed of a single polymer blend having the highest design melting temperature of all polymer blends of the IFC structure 200 such that it provides the IFC structure with failsafe operation by completely shutting down the flow of ions through the IFC structure when it has reached a maximum temperature that is set below a critical temperature. Those skilled in the art will readily understand that other configurations are possible for the second IFC layer 212 when it is provided.

It is noted that in FIG. 2A the optional support structure 208 and second IFC layer 212 are shown as extending beyond the bounds of the first IFC layer 204. This is done merely for the sake of illustration in the present plan view. In a physical instantiation, the various layers have any areal sizes deemed appropriate for a particular design.

FIG. 2B illustrates an example IFC structure 240 that includes a first IFC layer 244 composed of seven regions, namely six interior regions 244A(1) to 244A(6) and a surrounding region 244B. It is noted that while six interior regions 244A(1) to 244A(6) are illustrated, the number of interior regions can be greater than or fewer than six as desired to suit a particular design. In addition, while the interior regions 244A(1) to 244A(6) are shown as being circular in shape, they may be any shape desired, and their shapes need not all be the same, nor do the sizes of the interior regions need to be the same as one another. In this example, the entire surrounding region 244B may be provided with a polymer blend having a single design melting temperature, and each of the interior regions 244A(1) to 244A(6) may be provided with no polymer blend (no ionic flow blocking ability) or a polymer blend having a design melting temperature higher or lower than the surrounding region 244B. In one example, all six of the interior regions 244A(1) to 244A(6) may not have any polymer blend and no blocking ability. In this case, once the temperature of the IFC structure 240 reaches or exceeds the design melting temperature of the polymer blend in the surrounding region 244B, the surrounding region will block ionic flow but all six interior regions 244(1) to 244A(6) will continue to allow ions (not shown) to flow through the IFC structure 240. In another example, one, some, or all of the interior regions 244A(1) to 244A(6) may include corresponding respective polymer blends, each having a design melting temperature different from the design melting temperature in the surrounding region 244B and the same as or different from the design melting temperature of one or more others of the interior regions 244A(1) to 244A(6). Those skilled in the art will readily appreciate that many possible configurations exist for an IFC layer having one or more interior regions and a surrounding region, such as the first IFC layer 244 of FIG. 2B.

The IFC structure 240 of FIG. 2B may optionally include a support structure 248 for supporting the first IFC layer 244. The support structure 248 is sufficiently porous or otherwise open to the flow of ions of an electrolyte (not shown) from one side of the IFC structure 240 to the other, here, either into or out of the page relative to FIG. 2B. The support structure 248 is also robust enough to withstand at least the highest design melting temperature at which the first IFC layer 244 is designed to operate without losing its ability to support the first IFC layer 244. The support structure 248, when provided, is typically a separator that provides electrical separation between an anode and a cathode of an electrochemical device, for example, as discussed above relative to FIGS. 1A and 1B. Those skilled in the art will understand how to construct or provide a suitable support structure 248.

The IFC structure 240 of FIG. 2B may optionally include a second IFC layer 252, such as on the side of the support structure 248 opposite the side that the first IFC layer 244 is on. If present, the second IFC layer 252 may be configured, in terms of number, location, and size of the regions, in the same manner as the first IFC layer 244. In the example shown, in this case the second IFC layer 252 would have six interior regions 252A(1) to 252A(6) that match the interior regions 244A(1) to 244A(6) of the first IFC layer 244 and one surrounding region 252B that matches the surrounding region 244B but be located on the opposite side of the support structure 248. In embodiments in which the regions 252A(1) to 252A(6) and 252B of the second IFC layer 252 match the regions 244A(1) to 244A(6) and the surrounding region 244B of the first IFC layer 244, the individual regions may have the same or differing polymer blend, or none, as the corresponding individual region 244A(1) to 244A(6) and 244B on the opposite side of the support structure 248. In one example, if all of the interior regions 244A(1) to 244A(6) of the first IFC layer 244 do not have any polymer blend, and therefore no ionic flow blocking ability, then the corresponding interior regions 252A(1) to 252A(6) may have one or more polymer blends that melt at one or more temperatures higher than the polymer blend in the surrounding region 244B of the first IFC layer 244 to provide the desired ionic flow blocking ability in the interior regions 252A(1) to 252A(6). In some embodiments, the second IFC layer 252 may be configured differently from the configuration of the first IFC layer 244. For example, the entirety of the second IFC layer 252 may be composed of a single polymer blend having the highest design melting temperature of all polymer blends of the IFC structure 240 such that it provides the IFC structure with failsafe operation by completely shutting down the flow of ions through the IFC structure when it has reached a maximum temperature that is set below a critical temperature. Those skilled in the art will readily understand that other configurations are possible for the second IFC layer 252 when it is provided.

It is noted that in FIG. 2B the optional support structure 248 and second IFC layer 252 are shown as extending beyond the bounds of the first IFC layer 244. This is done merely for the sake of illustration in the present plan view. In a physical instantiation, the various layers have any areal sizes deemed appropriate for a particular design.

FIG. 2C illustrates an example IFC structure 280 that includes a first IFC layer 284 that, prior to any melting occurring, permits ions to flow through it (in a direction perpendicular to the page containing FIG. 2C) across its entire area. In this example, the first IFC layer 284 generally has one or more continuous gradients of design melting temperatures from one or more locations containing a polymer blend having a minimum design melting temperature TMmin, such as proximate to the edges 284(1) to 284(4) of the first IFC layer 284 as illustrated in FIG. 2C, to one or more locations containing a polymer blend having a maximum design melting temperature TMmax, such as at the geometric center 284A of the first IFC layer 284. As illustrated by temperature-gradient lines 288(1) to 288(4), the design melting temperature of the first IFC layer 284 from the edges 284(1) to 284(4) to the center 284A increases in a gradient from TMmin to TMmax. In this example, as the temperature of the first IFC layer 284 continues to increase from TMmin toward TMmax, the melted area, and hence the blocked area, of the first IFC layer increases until TMmax is reached or exceeded, at which point the entire first IFC layer has melted and blocks all ionic flow. In an embodiment in which the first IFC layer 284 is made from particles (not shown), particles of differing polymer blends having differing melting temperatures can be strategically placed and agglomerated with one another so as to provide the melting temperature gradient. Although not shown, one or more regions of the first IFC layer 284, such as a region surrounding the center 284A, may not have any polymer blend so as to remain unblocked after the first IFC layer has reached the maximum design melting temperature TMmax. The locations of TMmin and TMmax illustrated are only examples, as is the direction of temperature gradient (lines 288); many other configurations are possible using a temperature gradient technique. In the example of FIG. 2C, temperature-gradient lines 288(3) and 288(4) are dashed to indicate that in other embodiments, there is not a gradient in those directions, such that only gradients exist between the edge 284(2) and the geometric center 284A and between the edge 284(4) and the geometric center. In one example, the gradient lines (only one (288(1)) shown) on the left-hand side of the first IFC layer 284 are all parallel to one another, as are the gradient lines (only one (288(2)) shown) on the right-hand side of the first IFC layer such that the two gradients converge along a vertical (relative to the page of FIG. 2C) line (not illustrated) extending through the geometric center 284A of the first IFC layer.

The IFC structure 280 of FIG. 2C may optionally include a support structure 292 for supporting the first IFC layer 284. The support structure 292 is sufficiently porous or otherwise open to the flow of ions of an electrolyte (not shown) from one side of the IFC structure 280 to the other, here, either into or out of the page relative to FIG. 2C. The support structure 292 is also robust enough to withstand at least the highest design melting temperature at which the first IFC layer 284 is designed to operate without losing its ability to support the first IFC layer. The support structure 292, when provided, is typically a separator that provides electrical separation between an anode and a cathode of an electrochemical device, for example, as discussed above relative to FIGS. 1A and 1B. Those skilled in the art will understand how to construct or provide a suitable support structure 284. The IFC structure 280 of FIG. 2C may optionally include a second IFC layer 296, such as on the side of the support structure 292 opposite the side that the first IFC layer 284 is on. If present, the second IFC layer 296 may be configured in the same manner as the first IFC layer 284.

It is noted that in FIG. 2C the optional support structure 292 and second IFC layer 296 are shown as extending beyond the bounds of the first IFC layer 284. This is done merely for the sake of illustration in the present plan view. In a physical instantiation, the various layers have any areal sizes deemed appropriate for a particular design.

Example Polymer Blends and Melt-Temperature Tuning

As described above, thermal safety is of prime importance in electrochemical devices, such as lithium-metal batteries. Conventional lithium-ion batteries typically use a trilayer separator composed of a layer of polyethylene (PE) sandwiched between two layers of polypropylene (PP) as a shutdown separator. Once the internal temperature of a lithium-metal battery rises to the melting point of PE, the PE layer softens and melts to shut the pores of the separator, thus preventing ion motion. This type of separator often loses control over thermal runaway in practical applications, because the difference between the melting point of PE and PP is only 30° C. Thermal inertia after shutdown can easily cause the cell temperature to keep increasing until the melting point of PP, resulting in shrinking of separator and then internal shorting. Also, the melting point of PE and PP is quite close to the melting point of lithium, which is 180° C. For lithium-metal batteries, a shutdown function, for example at 100° C., is desirable. In some embodiments, combining shutdown functionality with the ceramic coated separator will allow for improved control over shrinkage.

In some examples, methods of the present disclosure may include the use of a common commercially available resin, such as polyethylene co-vinyl acetate (PEVA), among others. When an IFC layer of the present disclosure is made of particles, the resin may be diluted with an organic solvent, such as chloroform, among others, and then precipitated into a surfactant bath that modifies the surface tension to allow the facile formation of micron-sized spheres. In one example, PEVA microspheres were synthesized using a solvent evaporation technique. PEVA is a co-polymer blend of polyethylene and vinyl acetate, and changing the ratio of the two polymers in the polymer blend leads to a change in the melting point of the polymer blend. Thus, the melting point/profile can be accurately tuned.

In some embodiments, the microsphere morphology may be desirable due to high surface area leading to increased coverage of a support structure, such as a separator, with a lower mass loading of the PEVA polymer blend IFC layer. The density of the microspheres are very low, and therefore a very thin coating can be applied at an IFC layer without significantly affecting the gravimetric and volumetric energy density of the electrochemical cell in which the IFC layer is used. The microspheres present a very high surface area (SA) to volume (V) ratio particle (SA:V=3/r, wherein r is the radius of a particle). The microsphere morphology also prevents blockage of the ionic-flow passageways of the support structure prior to melting. The size of the microspheres may be tuned so they are much larger than the passageway size of the support structure. This ensures that the microspheres do not enter the passageways while the IFC layer is being applied. Also, since the microspheres naturally create interparticle spaces, there is space for ion motion through the passageways of the support structure. In some examples, the size of the microspheres may be in a range of 0.5 micron to 10 microns, in a range of 2 microns to 5 microns, in a range of 0.5 micron to 2 microns, or in a range of 4 microns to 8 microns, among others. The size of the microspheres can be adjusted, for example, by using a different surfactant and/or changing processing parameters. Those skilled in the art understand how microspheres and other microshapes can be made from polymer blends. In some embodiments, the thickness of an IFC layer of the present disclosure, such as any one of IFC layers 108, 112, 204, 244, and 284, may be in a range of 0.5 micron to 20 microns, in a range of 1 micron to 2 microns, in a range of 1 micron to 10 microns, or in a range of 1 micron to 5 microns, among others. In some embodiments, the coating forming an IFC layer of the present disclosure, such as any one of IFC layers 108, 112, 204, 244, and 284, may be in a range of 2 g/cm² to 20 g/cm², in a range of 2 g/cm² to 10 g/cm², or in a range of 2g/cm² to 5 g/cm², among others.

In one example, after drying the PEVA microspheres may then be coated on one surface of the support structure (e.g., separator) using a small amount of, for example, high molecular weight PVDF as a binder for creating a coating for the support structure. Another binder may be used. The coating may be applied, for example, using a solution-casting method that uses N-methyl-2-pyrrolidone (NMP) as a solvent, among others. As those skilled in the art will appreciate, the particle-based embodiments of this disclosure are not limited to using PEVA. Many polymer blends can be processed into microspheres, cubes, or other shapes, and applied to create a melting profile to tackle the high speed at which thermal runaway usually occurs. Following are some additional examples of polymer blends that can be used to make an IFC layer of the present disclosure, such as any of the IFC layers 108, 112, 204, 244, and 284 described above.

Generally, melting-temperature-tuned polymer blends suitable for use in an IFC layer of the present disclosure, such as any of the IFC layers 108, 112, 204, 244, and 248, may be composed of two or more polymers as co-polymers. In some embodiments, one of the polymers may be selected to provide mechanical strength, while each of the additional polymer(s) may be selected based on having a high melt index (e.g., greater than 5) and being soft so as to create a polymer blend having a desired combination of melting point and melt flow index. In one set of examples illustrated below in Table II, polyethylene is selected as the polymer to provide the mechanical strength, and the polyethylene is blended with at least one other polymer as indicated in Table II. As seen in Table II, each polymer blend is identified by the general nomenclature “poly(ethylene-co (B)-(C)”, wherein examples of B and C appear in Table II.

TABLE II

| | | % | % | Melt | Melting |
|---|---|---|---|---|---|
| | % | polymer | polymer | flow | point |
| Co-polymer | polyethylene | B | C | index | (° C.) |
| poly(ethylene-co- | 75-90 | 10-25 | 0 | 2.5-25 | 70-100 |
| vinyl acetate) | | | | | |
| poly(ethylene- | 65-69 | 25-30 | 1-5 | 6-50 | 70-80 |
| co-vinyl acetate- | | | | | |
| co methyl | | | | | |
| methacrylate) | | | | | |
| poly(ethylene-co- | 90-95 | 5-10 | 0 | 2.5-5 | 80-100 |
| methylmethacrylate) | | | | | |
| poly(ethylene- | 92 | 8 | 0 | 5 | 99 |
| co-glycidyl | | | | | |
| methacrylate) | | | | | |
| poly(ethylene-co- | 80-90 | 10-20 | 0 | 6-20 | 90-120 |
| ethyl acrylate) | | | | | |
| poly(ethylene-co- | 90-95 | 5-10 | 0 | 20-25 | 70-100 |
| methacrylic acid) | | | | | |

As seen in Table II, the various polymer blends can provide a range of design melting temperatures of 70° C. to 120° C. and a range of melt flow indices of 2.5 to 25. As a specific example from the above table, the polymer blend poly(ethylene-co vinyl acetate -co methylmethacrylate (MMA) may be composed of 74% polyethylene, 25% vinyl acetate, and 1% MMA. Many other specific polymer blends can be made using any one of the polymer blends in Table II and corresponding specific percentage amounts of the corresponding constituent polymers. Those skilled in the art will readily appreciate that the examples of Table II are nonlimiting and that other polymers can be used as the mechanical-strength polymer(s) and as the softer polymer(s).

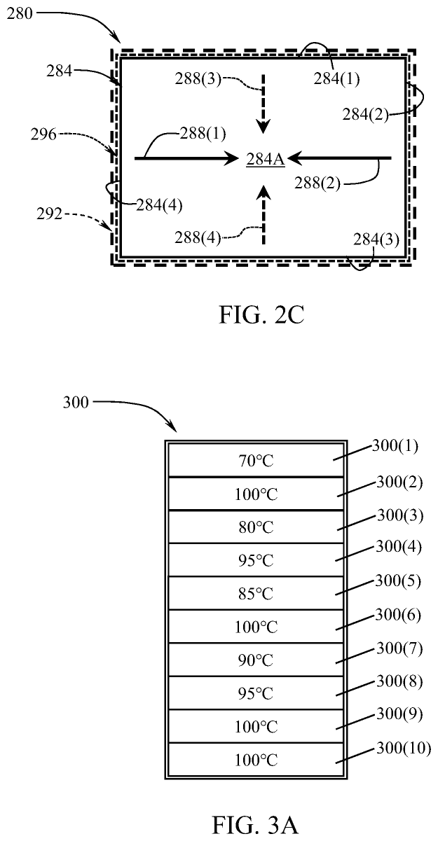

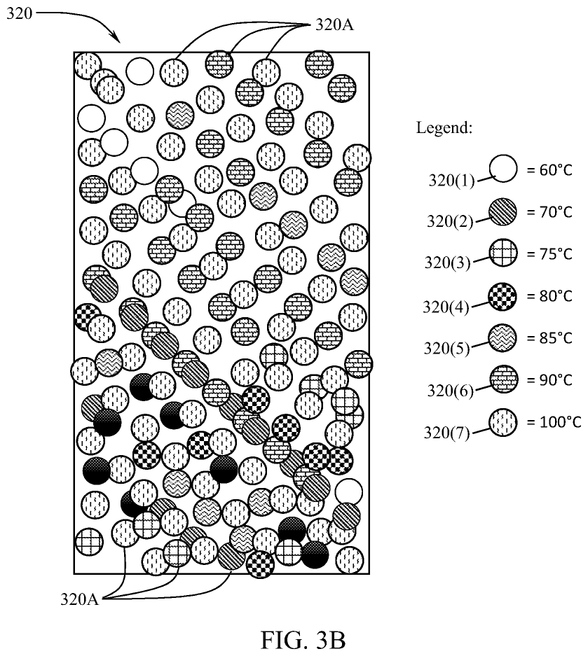

FIGS. 3A and 3B illustrate example IFC layers 300 and 320, respectively, made using polymer blends of Table II, above. Similar to FIG. 2A, FIG. 3A is an example in which differing regions 300(1) to 300(10) of differing polymer blends are provided in a striped arrangement. In this example, the differing polymer blends in regions 300(1) to 300(10) are denoted by their design melting temperatures as shown in FIG. 3A. As can be seen in FIG. 3A, the striped IFC layer 300 has ten regions 300(1) to 300(10) having six differing design melting temperatures, 70° C., 80° C., 85° C., 90° C., 95° C., and 100° C. This allows the IFC layer 300 to provide a gradual blocking of ionic flow as the temperature of the IFC layer rises from 70° C. to 100° C. and beyond. When the areas of the ten regions 300(1) to 300(10) are all the same, it can be seen in FIG. 3A that when the temperature of the IFC layer 300 is between 95° C. and 100° C., 40% of the IFC layer remains open to ionic flow.

Referring now to FIG. 3B, the IFC layer 320 of this example utilizes seven types of particles 320(1) to 320(7) (only labeled in the legend to avoid clutter), with each particle type having a unique polymer blend tuned to have a specific design melting temperature. In this example, the seven design melting temperatures are 60° C., 70° C., 75° C., 80° C., 85° C., 90° C., and 100° C., and the corresponding respective polymer blends may be made using the polymer blends identified in Table II, above. In an example, the particles 320A (only a few labeled to avoid clutter) of all of the particle types 320(1) to 320(7) are made to have the same size and shape. In an example, the particles 320A of one or more of the particle types 320(1) to 320(7) have a different size and/or shape relative to the particles in one or more of the other particle types. In an example, the particles 320A within any one or more of the particle types 320(1) to 320(7) may be of differing sizes and/or shapes. As can be seen in FIG. 3B, the particles 320A may be spaced apart from one another or touching one another as desired to suit a particular design. In a nonlimiting example, the differing particle types 320(1) to 320(7) may be provided to the IFC layer 320 in the percentages of Table III, below, wherein the percentages shown are relative to the mixture of particles 320A provided to the IFC layer.

TABLE III

| Particle | Melting Point | % in |
|---|---|---|
| Type | (° C.) | Mixture |
| 320(1) | 60 | 2.5 |
| 320(2) | 70 | 2.5 |
| 320(3) | 75 | 2.5 |
| 320(4) | 80 | 2.5 |
| 320(5) | 85 | 2.5 |
| 320(6) | 90 | 12.5 |
| 320(7) | 100 | 75 |

As can be from Table III, above, as the temperature of the IFC layer 320 rises to and then above 60° C., the differing particle types 320(1) to 320(7) increasingly melt and provide relatively small amounts of ionic flow blockage up to just below 100° C. Once the temperature of the IFC layer 320 reaches 100° C., the remaining 75% of the IFC layer melts to block ionic flow across the enture IFC layer.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A separator for an electrolytic device that utilizes an electrolyte containing ions, the separator comprising:
a porous body having a first side and a second side spaced from the first side, the porous body configured to allow movement of the ions through the porous body when the separator is immersed in the electrolyte in the electrolytic device; and
an ionic-flow-control layer functionally located relative to the porous body, wherein the ionic-flow-control layer comprises a first plurality of particles each comprising a first copolymer blend compositionally tuned to melt at a first design melting temperature, wherein:
when the ionic-flow-control layer has not been subjected to the first design melting temperature and the separator is immersed in the electrolyte, the ionic-flow-control layer has a porosity that allows movement of the ions through the ionic-flow-control layer and permit the ions to flow through the separator; and
when the ionic-flow-control layer has been subjected to the first design melting temperature or greater and the separator is immersed in the electrolyte, the first plurality of particles melt so as to reduce the porosity of the ionic-flow-control layer and thereby inhibit flow of the ions through the separator.

2. The separator of claim 1, wherein the porous body comprises a porous polymer having a melting temperature greater than the first design melting temperature.

3. The separator of claim 1, wherein the porous body comprises a porous polymer and a ceramic material coated onto the polymer.

4. The separator of claim 1, wherein the porous body comprises a ceramic material.

5. The separator of claim 1, wherein the first copolymer blend comprises a longer-chain polymer and a shorter-chain polymer.

6. The separator of claim 5, wherein the long chain polymer comprises polyethylene and the softer polymer comprises vinyl acetate.

7. The separator of claim 1, wherein the mean size of the first plurality of particles is in a range of about 1 microns to about 10 microns.

8. The separator of claim 1, wherein the average spacing between adjacent particles in the first plurality of particles is in a range of about 2 microns to about 5 microns.

9. The separator of claim 1, wherein each of the first plurality of particles is substantially spherical in shape.

10. The separator of claim 1, wherein each of the first plurality of particles is substantially cubical in shape.

11. The separator of claim 1, wherein the porous separator has a functional area, and at least 80% of the functional area is covered by the particular layer.

12. The separator of claim 1, wherein the first design melting temperature is in a range of about 60° C. to about 100° C.

13. The separator of claim 1, wherein the first design melting temperature is in a range of about 90° C. to about 120° C.

14. The separator of claim 1, wherein the ionic-flow-control layer is configured to further reduce flow of the ions through the separator when the temperature of the ionic-flow-control layer reaches a second design melting temperature higher than the first design melting temperature, the ionic-flow-control layer comprises a second plurality of particles each comprising a second copolymer blend compositionally tuned to melt substantially at the second design melting temperature so as to further reduce the porosity of the ionic-flow-control layer and thereby further inhibit flow of the ions through the separator.

15. The separator of claim 14, wherein the second plurality of particles are distributed throughout the first plurality of particles within the ionic-flow-control layer.

16. The separator of claim 14, wherein the ionic-flow-control layer has first and second regions that are distinct from one another, and the first plurality of particles are clustered with one another in the first region and the second plurality of particles are clustered with one another in the second region.

17. The separator of claim 16, wherein the first and second regions are both located on the first side of the porous body.

18. The separator of claim 16, wherein the first region is on the first side of the porous body and the second region is on the second side of the porous body.

19. The separator of claim 14, wherein the first design melting temperature is in a range of about 65° C. to about 100° C. and the second design melting temperature is in a range of about 90° C. to about 120° C.

20. The separator of claim 1, wherein the ionic-flow-control layer is located on each of the first and second sides of the porous body.
